(19) United States
(12) Patent Application Publication
(10) Pub. No.: US 2018/0111797 A1
(43) Pub. Date: Apr. 26, 2018

(54) ELEVATOR CAR WALL PANELS

(71) Applicant: Otis Elevator Company, Farmington, CT (US)

(72) Inventors: Aurelien Fauconnet, Isdes (FR); Frederic Beauchaud, Coullons (FR)

(21) Appl. No.: 15/730,838

(22) Filed: Oct. 12, 2017

(30) Foreign Application Priority Data
Oct. 26, 2016 (EP) 16290218.3

(51) Int. Cl. B66B 11/02

(52) U.S. Cl. CPC B66B 11/0253; B66B 11/0246; B66B 11/0206

(57) ABSTRACT

Elevator car wall panel systems and methods of installation including a wall panel having at least one first panel engagement element at a first end and at least one second panel engagement element at a second end, a frame having at least one frame engagement element configured to engage with the at least one first panel engagement element to removably engage the wall panel to the frame, and a panel securing assembly configured to engage with the at least one second panel engagement element to removably secure the wall panel to the frame.

### CROSS-REFERENCE TO RELATED APPLICATIONS

This application claims the benefit of European Application No. 16290218.3 filed on Oct. 26, 2016, which is incorporated herein by reference in its entirety.

### BACKGROUND

The subject matter disclosed herein generally relates to elevator car wall panels and, more particularly, elevator car wall panel systems having panel securing assemblies that secure elevator car wall panels to elevator car structural panels.

Elevator cars include structural frames to support the weight of the elevator car and passengers therein. The structural frames may not be aesthetically pleasing and thus wall panels may be installed to the structural frames to define (an) interior wall(s) of the elevator car. Such wall panels can be fixedly secured to the structural frames using fasteners to securely retain the wall panels against the structural frame. Such installations may be difficult to change out and/or perform maintenance on because a technician may be required to enter the elevator hoistway to release the wall panels from engagement with the structural frame. Thus, it may be advantageous to provide wall panels with easier installation and/or removal.

### SUMMARY

According to one embodiment, elevator car wall panel systems are provided. The elevator car wall panel systems include a wall panel having at least one first panel engagement element at a first end and at least one second panel engagement element at a second end, a frame having at least one frame engagement element configured to engage with the at least one first panel engagement element to removably engage the wall panel to the frame, and a panel securing assembly configured to engage with the at least one second panel engagement element to removably secure the wall panel to the frame.

In addition to one or more of the features described herein, or as an alternative, further embodiments of the elevator car wall panel systems may include that the panel securing assembly includes a locking element and an articulating element that is used to move the locking element from an open position to a closed position, wherein in the closed position the locking element secures the wall panel.

In addition to one or more of the features described herein, or as an alternative, further embodiments of the elevator car wall panel systems may include that the frame is a structural wall panel of an elevator car.

In addition to one or more of the features described herein, or as an alternative, further embodiments of the elevator car wall panel systems may include that the frame is at least one of a ceiling and a floor of an elevator car.

In addition to one or more of the features described herein, or as an alternative, further embodiments of the elevator car wall panel systems may include that the panel securing assembly is mounted to the frame.

In addition to one or more of the features described herein, or as an alternative, further embodiments of the elevator car wall panel systems may include that the panel securing assembly includes a face plate and an assembly engagement element, wherein the assembly engagement element is configured to engage with the second panel engagement element.

In addition to one or more of the features described herein, or as an alternative, further embodiments of the elevator car wall panel systems may include that the face plate is a kick plate at a base of the elevator car.

In addition to one or more of the features described herein, or as an alternative, further embodiments of the elevator car wall panel systems may include that the panel securing assembly is configured to secure a plurality of wall panels to the frame.

According to another embodiment, methods of installing wall panels of elevator cars are provided. The methods include engaging at least one first panel engagement element at a first end of a wall panel into at least one frame engagement element of a frame, articulating a panel securing assembly from an open position to a closed position to securely engage the panel securing assembly to at least one second panel engagement element at a second end of the wall panel.

In addition to one or more of the features described herein, or as an alternative, further embodiments of the methods may include that the panel securing assembly includes a locking element and an articulating element that is used to articulate the locking element from the open position to the closed position, wherein in the closed position the locking element secures the wall panel.

In addition to one or more of the features described herein, or as an alternative, further embodiments of the methods may include that the frame is a structural wall panel of an elevator car.

In addition to one or more of the features described herein, or as an alternative, further embodiments of the methods may include that the frame is at least one of a ceiling and a floor of an elevator car.

In addition to one or more of the features described herein, or as an alternative, further embodiments of the methods may include that the panel securing assembly is mounted to the frame.

In addition to one or more of the features described herein, or as an alternative, further embodiments of the methods may include that the panel securing assembly includes a face plate and an assembly engagement element, wherein the assembly engagement element is configured to engage with the second panel engagement element.

In addition to one or more of the features described herein, or as an alternative, further embodiments of the methods may include securing a plurality of wall panels to the frame with the panel securing assembly.

Technical effects of embodiments of the present disclosure include systems and methods for installing elevator car wall panels within an elevator car using a panel securing assembly. Further technical effects include easy and simple installation and/or removal of aesthetic elevator car wall panels.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2A is an elevation schematic illustration of an elevator car wall panel that can employ embodiments disclosed herein;

FIG. 2B is an elevation schematic illustration of another elevator car wall panel that can employ embodiments disclosed herein;

FIG. 3A is a schematic side elevator view of an elevator car wall panel system in accordance with an embodiment of the present disclosure;

FIG. 3B is an enlarged isometric schematic illustration of a first end of the elevator car wall panel system of FIG. 3A;

FIG. 3C is an enlarged isometric schematic illustration of a second end of the elevator car wall panel system of FIG. 3A;

FIG. 3D is an enlarged schematic side view illustration of the second end of the elevator car wall panel system of FIG. 3A;

FIG. 4A is a schematic illustration of a panel securing assembly in accordance with an embodiment of the present disclosure in an open position;

FIG. 4B is a schematic illustration of the panel securing assembly of FIG. 4A shown in an intermediate position;

FIG. 4C is a schematic illustration of the panel securing assembly of FIG. 4A shown in a closed position and securing a wall panel;

FIG. 5A is a schematic illustration of a first step of an installation process for elevator wall panels in accordance with an embodiment of the present disclosure;

FIG. 5B is a second step of the installation process showing installation of a first wall panel;

FIG. 5C is a third step of the installation process showing installation of three wall panels;

FIG. 5D is a fourth step showing the three wall panels installed and secured within an elevator car;

FIG. 6 is a schematic illustration of an elevator car wall panel system in accordance with an alternative embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “##” that is shown in FIG. X may be labeled “X##” and a similar feature in FIG. Z may be labeled “Z##.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

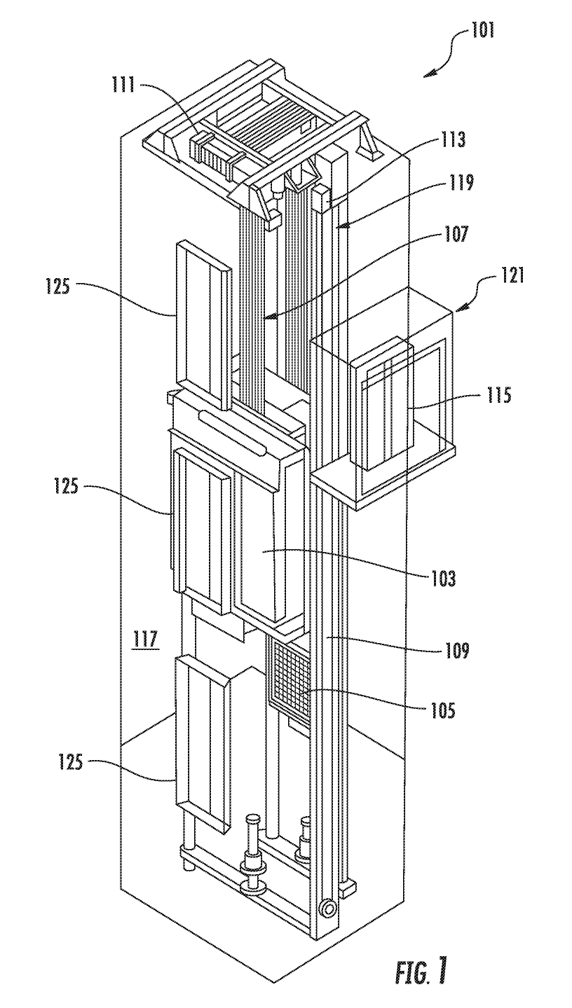

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

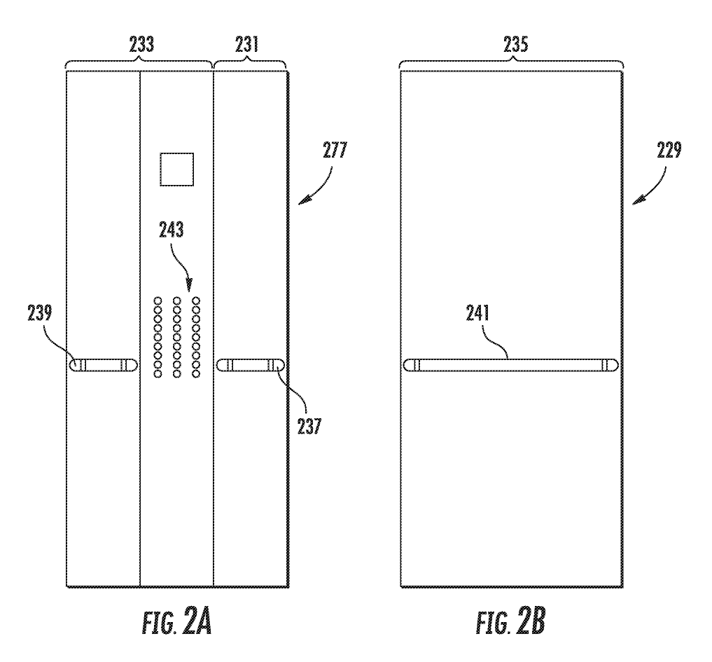

Turning to FIGS. 2A and 2B, schematic illustrations of elevator car wall panels 227, 229 that can employ embodiments described herein are shown. FIG. 2A shows a front elevation schematic view of a first elevator car wall panel 227. FIG. 2B shows a front elevation schematic view of a second elevator car wall panel 229. The first elevator car wall panel 227, as shown, includes two subpanels 231, 233, wherein a first subpanel 231 forms about a third of the elevator car wall panel 227 and the second subpanel 233 forms about two-thirds of the elevator car wall panel 227. That is, the first subpanel 231 and the second subpanel 233 are configured to form a wall of an elevator car. The two subpanels 231, 233, in some configurations, are parts of a solid or continuous elevator car wall panel, and thus are fixedly connected or are subparts of a continuous wall. The second elevator car wall panel 229 is formed with a single subpanel 235.

As shown, the first subpanel 231 of the first elevator car wall panel 227 includes an associated first handrail 237 and the second subpanel 233 includes an associated second handrail 239. The second elevator car wall panel 229 includes a third handrail 241. The handrails 237, 239, 241 are mounted to the respective subpanels 231, 233, 235 of the elevator car wall panels 227, 229 and provide users or passengers of the elevator to have a handrail to provide support or other function. Accordingly, ends of the handrails 237, 239, 241 are fixedly attached to, mounted to, and supported by the respective subpanels 231, 233, 235. Further, as shown, the second subpanel 233 of the first elevator car wall panel 227 includes an operation or control section 243. The control section 243, as shown, includes a number of buttons that are used to enable a passenger to select a destination floor, and may also include emergency buttons, or other buttons as known in the art.

The elevator car wall panels can be fixedly and semi-permanently installed to an elevator car structural panel or frame. For example, screws, bolts, or other fasteners can be used to fasten the panels to the elevator car structural panel. However, such configurations may not allow easy changing and/or replacement of such elevator car wall panels. Further, such configurations, due to the difficulty in replacing or changing the elevator car wall panels, can prevent or make difficult customization of the elevator car wall panels. Thus, changing an aesthetic of an elevator car wall panel may be difficult. Accordingly, embodiments provided herein are directed to elevator car wall panels and associated systems that enable easy installation, exchange, and/or replacement.

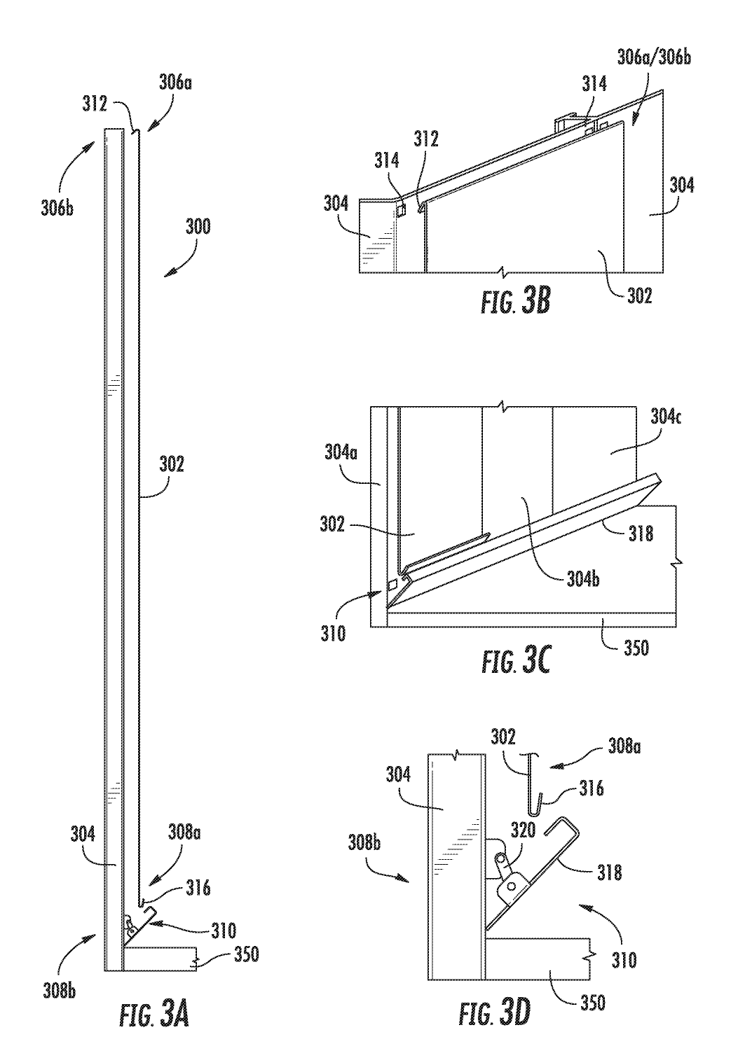

For example, turning now to FIGS. 3A-3D, an elevator car wall panel system 300 in accordance with a non-limiting embodiment of the present disclosure is shown. FIG. 3A illustrates a side view schematic of an elevator car wall panel 302 prior to installation and relative to an elevator car structural panel 304. FIG. 3B illustrates how the elevator car wall panel 302 installs to the elevator car structural panel 304 at a top or first end 306a of the elevator car wall panel 302 and a top or first end 306b of the structural panel 304. FIG. 3C illustrates how the elevator car wall panel 302 installs to the elevator car structural panel 304 at a bottom or second end 308a of the elevator car wall panel 302 and a bottom or second end 308b of the structural panel 304. FIG. 3D illustrates an enlarged schematic of a panel securing assembly 310 in accordance with an embodiment of the present disclosure.

As shown in FIG. 3A, a car wall panel 302, such as a decorative panel or other aesthetic panel, can be attached to the structural panel 304 (e.g., a structural wall of an elevator car). In the embodiment of FIGS. 3A-3D, the car wall panel 302 can be hung from or otherwise supported by the structural panel 304 at the first end 306. To enable engagement between the first end 306 of the wall panel 302 and the structural panel 304, the wall panel 302 can include a first panel engagement element 312. The first panel engagement element 312, as shown, can be a portion of material of the wall panel 302 that is bent or otherwise formed such that it can engage with a frame engagement element 314 formed in the car structural panel 304. As shown in FIG. 3B, the frame engagement element 314 can be an aperture formed within or through the structural panel 304. As such, in the present illustrative embodiment, the first panel engagement element 312 and the frame engagement element 314 can form a hole-and-hook arrangement. However, other arrangements and/or engagements are possible without departing from the scope of the present disclosure. As shown, a section of the structural panel 304 can support the wall panel 302 with two separate frame engagement elements 314. Although shown with two frame engagement elements 314, those of skill in the art will appreciate that any number of frame engagement elements can be employed. For example, a single long slot can be used to support the first end 306 of the wall panel, or a plurality of frame engagement elements can be configured along the first end 306 of the structural panel 304 that supports the wall panel 302.

At a second end 308 of the wall panel 302, the wall panel 302 can be configured to engage with the panel securing assembly 310. As shown, the panel securing assembly 310 is mounted to or otherwise fixed to the second end 308 of the structural panel 304. However, as will be appreciated by those of skill in the art, in some configurations, the panel securing assembly 310 can be mounted to the platform or floor 350 of the elevator car. To engage with the panel securing assembly 310, the wall panel 302 includes a second panel engagement element 316. The second panel engagement element 316 is configured to releasably secure with a locking element 318 of the panel securing assembly 310. The locking element 318, as shown, is hingedly mounted to the structural panel 304 by an articulating element 320, such as a hinge or pivot. The articulating element 320 enables the locking element 318 to open and close to be able to receive and then secure the second end 308 of the wall panel 302.

Accordingly, embodiments of the present disclosure separate a structural element (e.g., structural panel 304) and an aesthetic panel (e.g., wall panel 302) of an elevator car. The structural panel 304 is fixed directly on or to an elevator car platform and/or ceiling, as will be appreciated by those of skill in the art. The wall panels 302 can then be fixed on their top by the first panel engagement element 312 (e.g., a bend or hook) and the frame engagement element 314 (e.g., a hole or aperture in the car structural panel 304). The wall panel 302 can be fixed at a second end by the panel securing assembly 310.

The panel securing assembly 310 can provide various functions. For example, in some configurations, the locking element 318 of the panel securing assembly 310 can be a kickplate or other structural element that protects the second end 308a of the wall panel 302. Further, in some configurations, the locking element 318 can be designed to provide an aesthetic aspect within an elevator car. Moreover, in some configurations, the panel securing assembly 310 can provide a quick-release functionality, such as a release toggle clamp, at the second end 308a of the of the wall panel 302.

As shown in FIG. 3C, the car structural panel 304 can include multiple structural subpanels 304a, 304b, 304c, wherein each structural subpanel 304a, 304b, 304c includes one or more frame engagement elements 314 at a first end 306b to support a respective wall panel. As shown in FIG. 3C, one wall panel 302 is hung from a first structural subpanel 304a and no wall panels are hung from the second and third structural subpanels 304b, 304c. However, as will be appreciated by those of skill in the art, each structural subpanel 304a, 304b, 304c can support a respective wall panel, and thus individual wall panels can be installed and/or exchanged without the need to remove all wall panels during a maintenance operation. In such a configuration, the panel securing assembly 310 can be mounted to one or more of the structural subpanels 304a, 304b, 304c.

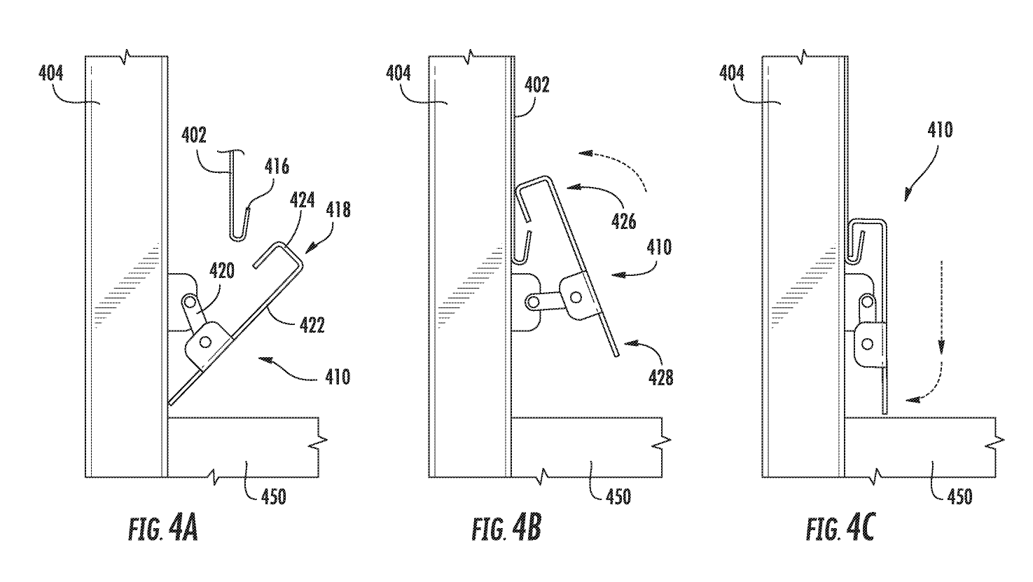

Turning now to FIGS. 4A-4C, a series of schematic illustrations are provided to detail operation of a panel securing assembly 410. As shown, the panel securing assembly 410 includes a locking element 418 and an articulating element 420 that enables movement, engagement, and securing of the locking element 418 with a second panel engagement element 416 of a wall panel 402. As shown, and as described above, the articulating element 420 is mounted to a car frame or structural panel 404, although other mounting configurations are possible without departing from the scope of the present disclosure, e.g., mounted to an elevator platform or floor 450.

FIG. 4A illustrates the panel securing assembly 410 in an open position. In the open position, the panel securing assembly 410 can receive a wall panel 402 or allow the wall panel 402 to be removed. As shown, the locking element 418 includes a face plate 422 and an assembly engagement element 424. The assembly engagement element 424 is configured to engage with the second panel engagement element 416. As shown by the dashed line/arrows of FIGS. 4B-4C, the wall panel 402 can be moved or placed against the structural panel 404. With the wall panel 402 against the structural panel 404, the locking element 418 can be articulated about the articulating element 420 into an intermediate position, e.g., rotated toward the wall panel 402 as shown in FIG. 4B. When a first end 426 of the locking element 418 is in the intermediate position (FIG. 4B), a second end 428 of the locking element 418 can be forced toward the structural panel 404 and downward toward the platform 450, as illustrated in FIG. 4C (e.g., a closed position). Such operation can allow for secure engagement between the panel securing assembly 410 and the wall panel 402, and thus the wall panel 402 can be secured to the structural panel 404. Those of skill in the art will appreciate that a reverse process (e.g., order of FIG. 4C to FIG. 4A) can be performed to remove a wall panel from installation.

In some embodiments, the panel securing assembly can include a lock and key to secure the panel securing assembly in the closed position. As such, unauthorized operation of the panel securing assembly can be prevented. In some embodiments, the face plate 422 can be textured, colored, patterned, or otherwise configured to aesthetically fit within the elevator car, e.g., match a look of the elevator car wall panels that are to be installed as described herein.

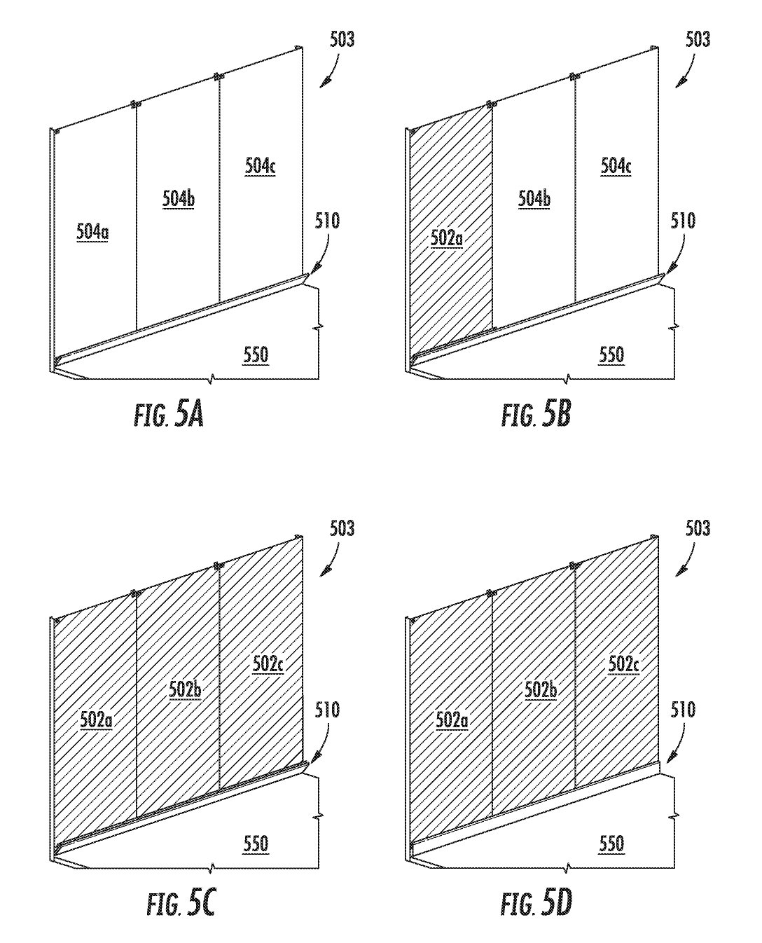

Turning now to FIGS. 5A-5D, a series of schematic illustrations are provided to show an example of installation of multiple wall panels in an elevator car that includes a panel securing assembly in accordance with an embodiment of the present disclosure. As shown, an elevator car 503 includes a platform or floor 550 and a number of structural subpanels 504a, 504b, 504c. As shown in the progression of FIGS. 5A-5D, a number of wall panels 502a, 502b, 502c are installed on or to a respective structural subpanel 504a, 504b, 504c. The wall panels 502a, 502b, 502c and the structural subpanels 504a, 504b, 504c are configured similar to the wall panels and frame/structural subpanels shown and described above, thus similar features will not be described again.

As shown in FIG. 5A, a panel securing assembly 510 can be set in an open position (e.g., as shown in FIG. 4A). With the panel securing assembly 510 in the open position, the wall panels 502a, 502b, 502c can be hung from the respective structural subpanels 504a, 504b, 504c as described above and shown in FIGS. 5B-5C. Once all wall panels 502a, 502b, 502c are hung from the respective structural subpanels 504a, 504b, 504c, the panel securing assembly 510 can be articulated from the open position into the closed position (e.g., as shown in FIG. 4C). Thus, the wall panels 502a, 502b, 502c can be fixedly secured to the elevator car frame or structural panel(s) but may be easily uninstalled or removed. As shown in FIGS. 5A-5D, a single panel securing assembly 510 can be configured to engage with a number of different wall panels 502a, 502b, 502c. In other configurations, a larger wall panel that spans an entire wall of an elevator car can be used, as will be appreciated by those of skill in the art.

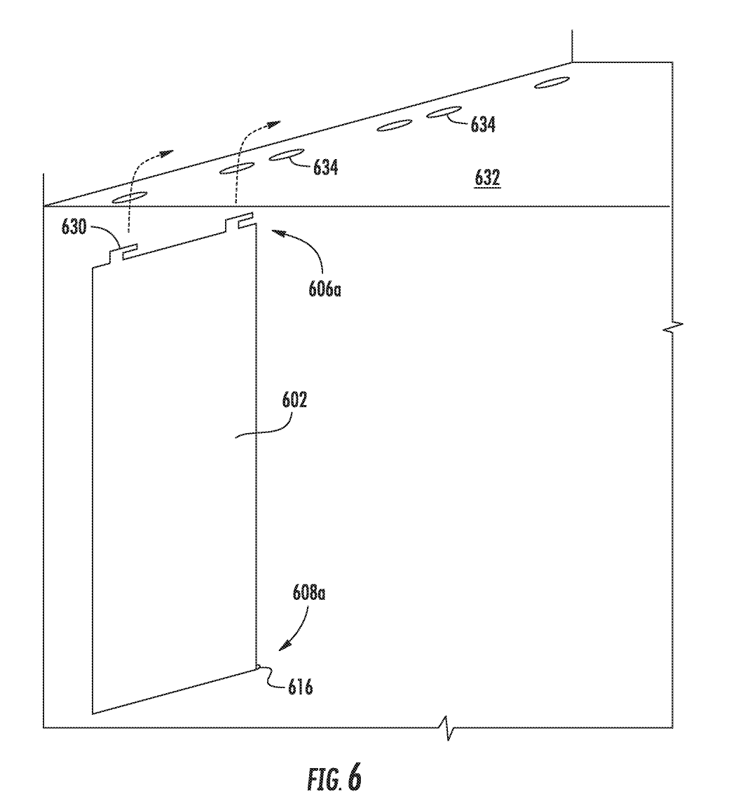

Although described herein with the wall panels engaging with the car frame or structural panels at the first end (e.g., top of the panel/frame), other configurations are possible without departing from the scope of the present disclosure. For example, with reference to FIG. 6, a wall panel 602 having first panel engagement elements 630 at a first end 606a and second panel engagement element 616 at a second end 608a is shown. The first panel engagement elements 630, in contrast to the embodiments shown and described above, are configured to engage with a ceiling 632 of an elevator car. That is, the ceiling of the elevator car can include frame engagement elements 634 that enable the wall panel 602 to hang from the ceiling. At the second end 608a, the wall panel 602 includes the second panel engagement element 616 that can be secured using a panel securing assembly similar to that shown and described above.

Further, although shown and described with the wall panels “hanging” at a top end and then being secured at a bottom end with a panel securing assembly as described herein, such configuration is not intended to be limiting. For example, the opposite configuration of that shown and described herein is possible. In such a configuration, the wall panels may engage with hooks or other elements at a bottom end and then be secured by a panel securing assembly that is positioned at a top of the elevator car (e.g., proximate the ceiling or in/on the ceiling).

Those of skill in the art will appreciate that various example embodiments are shown and described herein, each having certain features in the particular embodiments, but the present disclosure is not thus limited. That is, features of the various embodiments can be exchanged, altered, or otherwise combined in different combinations without departing from the scope of the present disclosure. Further, additional features and/or components can be incorporated into customizable elevator handrails as provided herein without departing from the scope of the present disclosure.

Advantageously, embodiments described herein provide elevator wall panel systems that allow for easy installation and/or replacement. For example, employing panel securing assemblies as provided herein, an elevator car aesthetic can be easily replaced and/or changed without the need of hoistway access. That is, when replacing elevator car wall panels, a technician need not access the hoistway to remove the wall panels. Rather, the technician can remain within the elevator car and easily remove, replace, and/or install wall panels. As will be appreciated by those of skill in the art, advantageously, embodiments provided herein can enable customization of an elevator car aesthetic without difficulty, and further such aesthetic can be easily changed.

Furthermore, advantageously, the ease of removability of the wall panels can improve efficiency of elevator maintenance. For example, if a technician needs to access an opening or electric panel of the elevator car, such openings and/or electrical panels can be hidden behind the wall panels of the present disclosure, but can be easily removed to enable any appropriate maintenance.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A elevator car wall panel system comprising:
a wall panel having at least one first panel engagement element at a first end and at least one second panel engagement element at a second end;
a frame having at least one frame engagement element configured to engage with the at least one first panel engagement element to removably engage the wall panel to the frame; and
a panel securing assembly configured to engage with the at least one second panel engagement element to removably secure the wall panel to the frame.

2. The elevator car wall panel system of claim 1, wherein the panel securing assembly comprises:
a locking element; and
an articulating element that is used to move the locking element from an open position to a closed position, wherein in the closed position the locking element secures the wall panel.

3. The elevator car wall panel system of claim 1, wherein the frame is a structural wall panel of an elevator car.

4. The elevator car wall panel system of claim 1, wherein the frame is at least one of a ceiling and a floor of an elevator car.

5. The elevator car wall panel system of claim 1, wherein the panel securing assembly is mounted to the frame.

6. The elevator car wall panel system of claim 1, wherein the panel securing assembly includes a face plate and an assembly engagement element, wherein the assembly engagement element is configured to engage with the second panel engagement element.

7. The elevator car wall panel system of claim 6, wherein the face plate is a kick plate at a base of the elevator car.

8. The elevator car wall panel system of claim 1, wherein the panel securing assembly is configured to secure a plurality of wall panels to the frame.

9. A method of installing wall panels of an elevator car, the method comprising:
engaging at least one first panel engagement element at a first end of a wall panel into at least one frame engagement element of a frame; and
articulating a panel securing assembly from an open position to a closed position to securely engage the panel securing assembly to at least one second panel engagement element at a second end of the wall panel.

10. The method of claim 9, wherein the panel securing assembly comprises:
a locking element; and
an articulating element that is used to articulate the locking element from the open position to the closed position, wherein in the closed position the locking element secures the wall panel.

11. The method of claim 9, wherein the frame is a structural wall panel of an elevator car.

12. The method of claim 9, wherein the frame is at least one of a ceiling and a floor of an elevator car.

13. The method of claim 9, wherein the panel securing assembly is mounted to the frame.

14. The method of claim 9, wherein the panel securing assembly includes a face plate and an assembly engagement element, wherein the assembly engagement element is configured to engage with the second panel engagement element.

15. The method of claim 9, further comprising securing a plurality of wall panels to the frame with the panel securing assembly.
